(19) United States
(12) Patent Application Publication
(10) Pub. No.: US 2003/0156887 A1
(43) Pub. Date: Aug. 21, 2003

(54) Back flow preventing mechanism for writing implement

(76) Inventors: Jason E. Cantu, Downers Grove, IL (US); Bret R. Marschand, Oak Park, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/078,836

(22) Filed: Feb. 19, 2002

(51) Int. Cl. B43K 5/02

(52) U.S. Cl. 401/232; 401/222

(57) ABSTRACT

A mechanism for a writing implement prevents back flow of writing fluid from a writing tip back to a fluid reservoir of the implement. The mechanism has a valve chamber with a proximal end and a distal end. The mechanism also has a valve seat disposed at the distal end of the valve chamber. A first fluid passage in the writing implement defines a first opening into the valve chamber at the valve seat. The first fluid passage is in fluid communication with both the fluid reservoir and the valve chamber. A valve body has a body diameter and is loosely held within the valve chamber. The valve body prevents fluid back flow from the valve chamber to the first fluid passage when borne against the valve seat. A second fluid passage in the writing implement is in fluid communication with both the writing tip and the valve chamber. The second fluid passage has a second opening disposed at the proximal end of the valve chamber. The second fluid passage has a generally oblong cross section that is sized relative to the valve body diameter so as to prevent the valve body from fully entering the second fluid passage and yet permit fluid flow to the writing tip when the valve body is borne against the entry of the second fluid passage.

### FIELD OF THE INVENTION

The invention is generally related to writing implements, and more particularly to a mechanism for preventing back flow of writing fluid in a liquid type writing implement from a writing tip to an ink reservoir in the writing implement.

### BACKGROUND OF THE INVENTION

Many writing implements today utilize a fluid such as ink as the writing medium. One problem with this type of writing implement is that the implement tends to function poorly when the writing tip is oriented or elevated above the fluid reservoir. The writing fluid tends to flow back to the reservoir instead of flowing to the writing tip, and thus, writing with the implement in this inverted orientation is poor or impossible. Fluid back flow in a writing implement can also create air bubbles in the fluid column which, when the writing tip is again oriented below the fluid reservoir in a normal writing orientation, can cause a complete or partial stoppage in flow of writing fluid to the writing tip.

A known solution to this common problem is to provide a back flow valve between the writing tip end of the implement and the fluid reservoir. A typical back flow valve has a valve body that bears against a valve seat when the writing tip is oriented above the fluid reservoir. The valve body in this position prevents any back flow of writing fluid from the writing tip to the reservoir.

When the writing tip is oriented in the normal writing position below the fluid reservoir, such back flow valve devices are designed so that the valve body moves away from the valve seat, permitting fluid to flow from the reservoir. These valve devices typically include a structure or means to prevent movement of the valve body toward the writing tip, and yet permit fluid to flow through the valve device, to bypass the valve body, and to reach the writing tip. Various structures and means have been proposed and developed that perform this function and are the subject of numerous patents. Examples of these structures are described in, for example, U.S. Pat. No. 5,348,411 (Ozu et al.), U.S. Pat. No. 5,678,942 (Kobayashi et al.), and U.S. Pat. No. 6,283,662 (Inoue et al.).

A number of these known valve structures are incorporated directly on a distal or rear end of the writing tip. In one known example, the writing tip end has a diameter that is smaller than the valve body. A plurality of grooves are formed in the end of the writing tip to allow fluid to bypass the valve body when it rests against the rear end of the writing tip.

In another example, a plurality of ridges or ribs are formed on the writing tip rear end and extend radially inward into the path of the valve body to block its forward movement. The ridges or ribs defme a plurality of grooves between them that permit fluid to bypass the valve body when it is borne against the ribs or ridges. The valve body rests on the ridges and is prevented from moving further toward the writing tip, and the grooves permit fluid to flow to the writing tip.

In yet another example, a plurality of ridges extend radially inward from a wall of a fluid passage at one end of a valve chamber that holds the valve body. The ridges again define a plurality of grooves between them. The grooves permit fluid to bypass the valve body as the ridges prevent the body from movement toward the writing tip.

Forming these types of ridge, rib, and/or groove structures in plastic components requires significant tooling, labor, and material expense in order to make, finish, and use the molds and molding processes that produce projection and/or groove structures. For other of these types of structures, machining processes must be performed after initial fabrication of metal writing tips in order to create the projection and/or groove structures in the writing tip ends.

### BRIEF DESCRIPTION OF THE DRAWINGS

Exemplary fluid back flow preventing mechanisms in accordance with the teachings of the present invention are described and explained in greater detail below with the aid of the drawing figures in which:

FIG. 1 is a cross section of one example of a writing implement and back flow preventing mechanism constructed in accordance with the teachings of the present invention.

FIG. 2 is an enlarged view of the longitudinal cross section of the coupling and writing tip portion of the implement shown in FIG. 1 and in a normal writing tip down orientation.

FIG. 3 is a longitudinal cross section of the coupling taken along line III-III in FIG. 2.

FIG. 4 is a lateral cross section through the coupling taken along line IV-IV in FIG. 2.

FIG. 5 is a lateral cross section through the coupling taken along line V-V in FIG. 2.

FIG. 6 is a longitudinal cross section of the coupling shown in FIG. 2 and in an inverted writing tip up orientation.

### DETAILED DESCRIPTION OF THE INVENTION EMBODIMENTS

The present invention is directed to a valve mechanism for preventing fluid back flow in a writing implement. The valve mechanism described herein eliminates the need for providing ridges, ribs, and/or grooves on any portion of the writing implement as disclosed in the prior art described above. The valve mechanism disclosed and described herein utilizes only a plurality of fluid passages of various shape and longitudinally arranged to accomplish the necessary back flow prevention functions. The disclosed mechanism is simpler in design, less expensive to produce, and easier to fabricate than previously known valve designs.

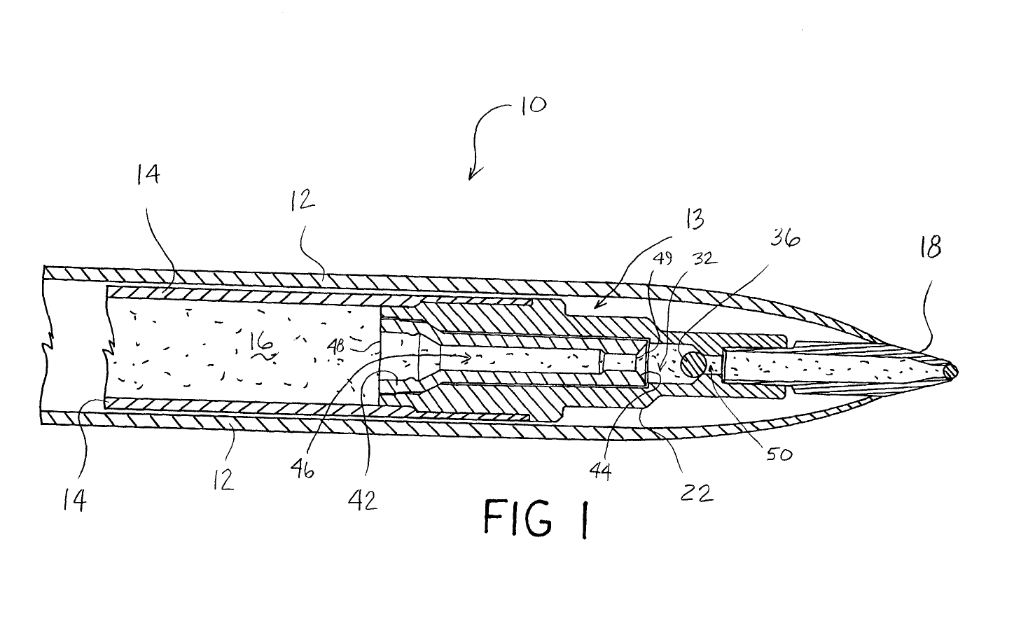

Referring now to the drawings, FIG. 1 discloses a cross section of one example of a writing implement 10 that utilizes a fluid as the writing medium. One liquid or fluid medium is widely known as ink and is used in many writing implements including those having a ball type writing tip that lays down the ink. The writing implement structure shown in FIG. 1 is merely one of many possible examples. The part configuration and arrangement can vary considerably from that shown in FIG. 1 and yet fall within the scope and spirit of the present invention.

The writing implement 10 generally includes an outer decorative shell or case 12, typically in the form of an elongate circular cylinder or tube. The tube 12 often houses, in one example, an ink refill assembly 13 that generally has a fluid reservoir 14, a reserve of writing fluid 16 within the reservoir, and a writing tip 18. In this example, the fluid reservoir 14 is also a circular cylinder or tube and is of a smaller diameter than the case 12. In one example, the fluid medium 16 is an ink composition and is stored as a fluid column in the reservoir tube 14. Though the term “ink refill ” is used herein to describe the internal assembly of the writing implement, the assembly need not be a removable and replaceable refill, per se. It can be a permanent, disposable part of a given writing implement, if so desired. Further, the reservoir and writing tip structures can vary considerably from those described herein and yet fall within the scope and spirit of the present invention.

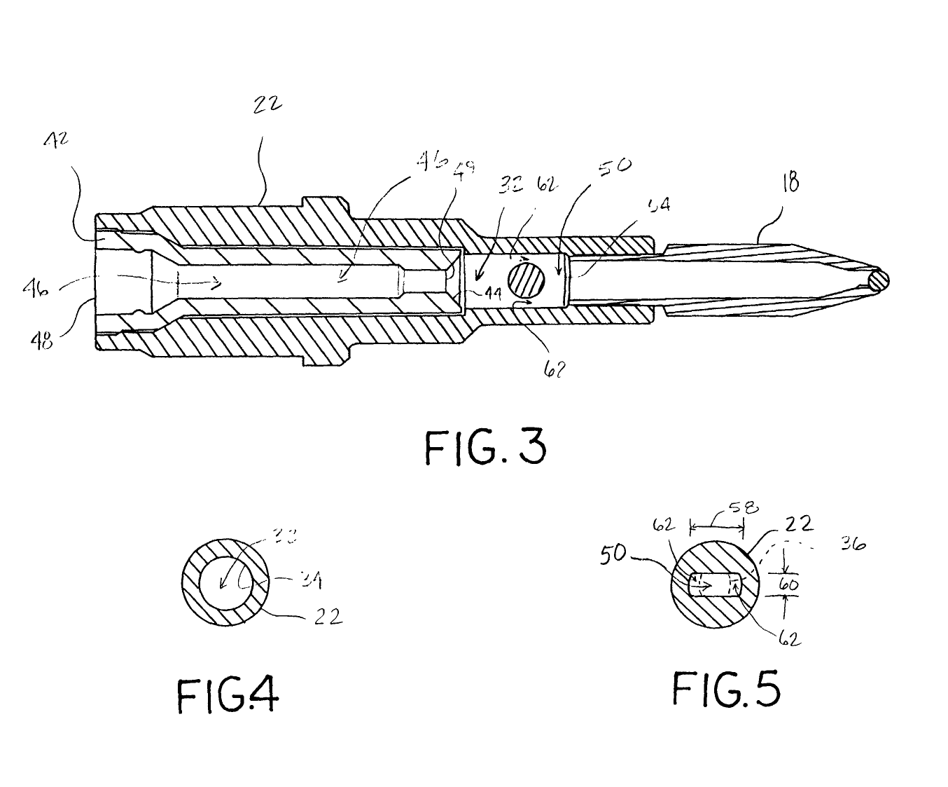

Referring to FIGS. 1-3, the writing tip 18 in this example has a writing ball 20 installed at its proximal most tip in a manner known to those having ordinary skill in the art. Hereinafter, the writing tip end is generally referred to as the “proximal end ” of the implement 10, and the opposite end of the implement is generally referred to as the “distal end ” merely for ease of description herein. Similarly, the terms “distal end ”and “proximal end ” as used herein for describing specific parts or components of the implement also correspond to the like named ends of the implement, also for ease of description.

In the present example, the refill assembly 13 also has a coupling 22 assembled between the fluid reservoir 14 and the writing tip 18. The coupling 22 generally has a proximal end 24 connected to the writing tip 18 and a distal end 26 connected to the reservoir 14. In the disclosed example, the writing tip 18 has a cylindrical distal end section 28 that is snugly received within a larger diameter cylindrical tip holding section 30 of the coupling 22. As will be evident to those having ordinary skill in the art, the configuration and structure for connecting the writing tip 18 to the implement 10, refill assembly 13, and/or coupling 22 can vary considerably and yet fall within the scope and spirit of the present invention.

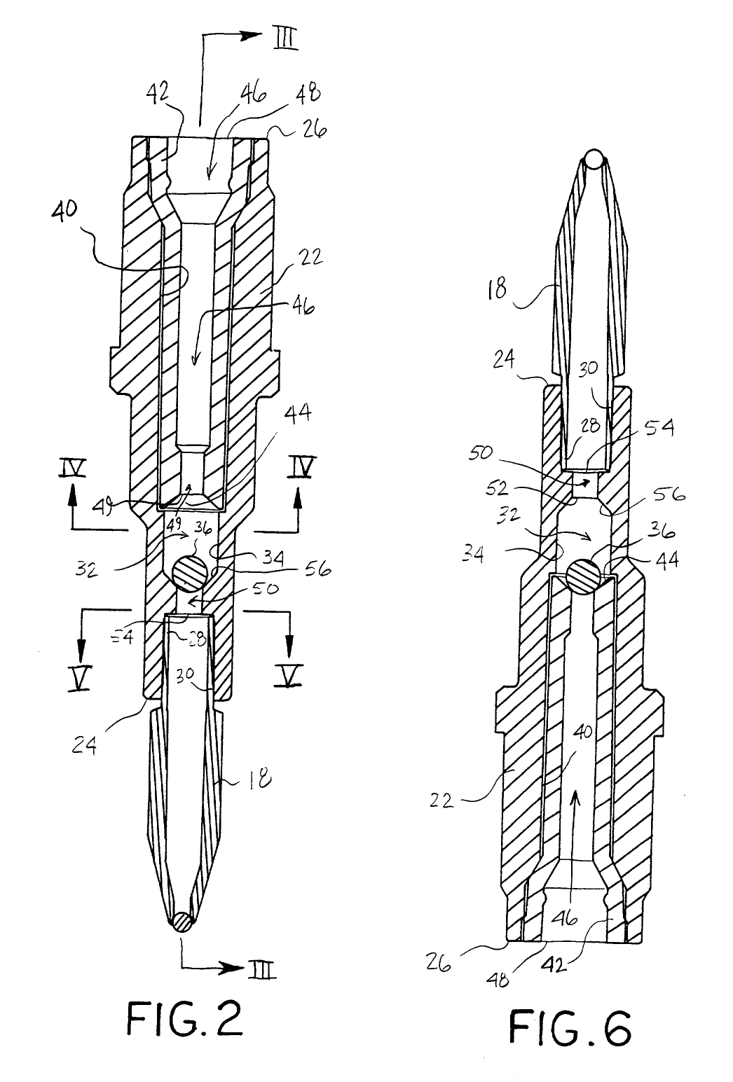

Referring to FIGS. 2-5, the coupling 22 in the disclosed example generally has a segmented longitudinal bore extending completely through the coupling. One of the bore segments defines a valve chamber 32 disposed within the coupling between the proximal and distal ends 24 and 26, respectively. The valve chamber 32 in this example is shown in cross section in FIG. 4 and is generally a circular cylinder defmed by a smooth or protrusion free chamber wall 34. A valve body 36 is loosely housed in the valve chamber 32. In this example, the valve body 36 is a spherical body having a body diameter and is typically fabricated from a metallic material. However, the valve body can be formed from different materials and can have a different shape, as desired or required for a particular writing implement without departing from the spirit and scope of the present invention.

Another longitudinal bore segment of the coupling 22 is a bore section 40 extending through the portion of the coupling from the distal end 26 and terminating at the distal end of the valve chamber 32. A valve seat insert 42 is inserted in the bore section 40 from the distal end 26 of the coupling 22. The seat insert 42 defines a valve seat 44 on its proximal end surface. The valve seat 44 faces into and defines the distal end of the valve chamber 32 when the seat insert 42 is fully installed. The seat insert 42 also has a distal end surface that lies generally flush or co-planar with the distal end 26 of the coupling 22 when fully installed. A first fluid passage or delivery port 46 extends through the seat insert 42. The passage 46 has a fluid inlet 48 at the distal end of the insert and a discharge opening 49 defined at the proximal end of the insert and circumscribed by the valve seat 44. The discharge opening 49 opens into the valve chamber 32.

Another longitudinal bore segment of the coupling 22 is a second fluid passage or supply port 50 disposed between and in fluid communication with both the proximal end of the valve chamber 32 and the writing tip 18. The second passage 50 begins at a fluid entry opening 52 that opens into the proximal end of the valve chamber 32. The second passage 50 terminates at a fluid outlet 54 that opens into the writing tip 18 when the tip is fully installed in the tip holding section 30 of the coupling 22. In the present example, a tapered surface 56 is formed at the entry opening 52. The tapered surface 56 is optional, but as described in greater detail below, can assist in properly registering the valve body 36 during use of the writing implement 10.

In the disclosed example, the first fluid passage or delivery port 46 is essentially a circular cylinder having a diameter smaller than the valve body diameter. The valve chamber 32 is also a circular cylinder in this example, as noted above, and has a diameter that is larger than the valve body diameter so as to permit the body 36 to move relatively freely within the valve chamber between the valve seat 44 and the entry opening 52.

The second fluid passage or supply port 50 is non-circular and, as disclosed in this example, has an oblong shape in cross section as illustrated in FIG. 6. The oblong second fluid passage 50 has a major length dimension 58 and a minor width dimension 60. The major length dimension 58 is greater than the diameter of the valve body 36 and the minor width dimension 60 is smaller than the diameter of the valve body. The minor dimension 60 is less than the diameter of the valve body 36 to restrict the size of the second passage 50 so that the valve body cannot pass into and through the second passage. The minor dimension 60 at the entry opening 52 thus acts to support the valve body. The major dimension 58 of the passage assures that flow paths or portions 62 of the entry opening 52 are open and not blocked by the valve body 36 when resting on the entry opening. One or two of these portions or fluid flow paths 62 will be present and open when the valve body is resting at the entry opening 52, depending upon where the body is situated relative to the longitudinal axis of the coupling 22. The size of the major length dimension 58 relative to the diameter or size of the valve body 36 can be selected to create a desired size of the open portions 62 to achieve an adequate fluid flow rate.

During use, and as shown in FIG. 6, when the writing tip 18 is positioned above the fluid reservoir tube 14 relative to a horizontal plane, the valve body 36 is borne against the valve seat 44. The valve seat 44 has a shape that corresponds with the shape of the valve body so as to completely close off the delivery port 46 and prevent back flow of any fluid to the reservoir 14 from the valve chamber 32 and writing tip 18.

When the writing implement 10 is positioned in a normal writing orientation as shown in FIG. 2, the writing tip 18 is below the fluid reservoir tube 14 relative to a horizontal plane. In this orientation, the valve body 36 moves toward the second fluid passage or supply port 50 and bears against the entry opening 52. In this example, the valve body is received in and bears against the tapered surface 56 when in such orientation. Fluid is permitted to flow from the reservoir tube 14 through the first fluid passage or delivery port 46 and into the valve chamber 32. The minor width dimension 60 of the second fluid passage 50 restricts the valve body 36 from entering the passage. The major length dimension 58 permits fluid to flow from the valve chamber 32 around the valve body 36 and into the second fluid passage 50 via the portions or fluid flow paths 62. Fluid is therefore supplied to the writing tip 18 to replenish the writing ball 20 as needed.

In the disclosed example, the oblong cross sectional shape of the second fluid passage or supply port 50 is generally rectangular with slightly rounded corners and with slightly curved short side dimensions. As will be evident to those having ordinary skill in the art, the shape of the second fluid passage can be oval, elliptical, rectangular, or the like, as long as the shape adequately performs the above-described attendant function. Also, the valve body need not be spherical in shape, but can vary as needed for a particular application. The valve body cross section and second fluid passage cross section must compliment one another to prevent the body from passing into and through the passage and yet permit fluid to flow into the passage. Further, the valve chamber cross section need not be circular in shape. However, the chamber must be shaped to correspond with the valve body in order to permit fluid flow between the chamber wall or walls 34 and the valve body 36 and to permit the ball to move within the chamber.

The back flow preventing mechanism described herein eliminates the need to form projections, ribs, or ridges extending from walls within the mechanism or an end of the writing tip, and also does not require forming grooves in the walls or between projections within the mechanism as do the previously known solutions. The mechanism essentially utilizes only different passage cross section shapes aligned in series to achieve the desired valve functions. The disclosed mechanism is a simpler, less expensive, and easier to manufacture solution to prevent fluid back flow in writing implements.

The various components can be fabricated from virtually any suitable material. In one example, the coupling 22 and the valve insert 42 are molded from a plastic or thermoplastic material. The disclosed mechanism is not to be limited in any way to particular component materials.

Although certain back flow valve mechanisms have been disclosed and described herein in accordance with the teachings of the present invention, the scope of coverage of this patent is not limited thereto. On the contrary, this patent covers all embodiments of the teachings of the invention fairly falling within the scope of the appended claims, either literally or under the doctrine of equivalents.

What is claimed is:

1. A fluid back flow preventing mechanism for a writing implement with a writing tip, the mechanism comprising:
a valve chamber having a proximal end and a distal end;
a valve seat disposed at the distal end of the valve chamber;
a first fluid passage defining a first opening to the valve chamber at the valve seat, the first fluid passage in fluid communication with both a fluid reservoir and the valve chamber;
a valve body having a body diameter and loosely held within the valve chamber, the valve body preventing fluid back flow from the valve chamber to the first fluid passage when borne against the valve seat; and
a second fluid passage in fluid communication with both the writing tip and the valve chamber and having a second opening disposed at the proximal end of the valve chamber, the second fluid passage having a generally oblong cross section that is sized relative to the valve body diameter so as to prevent the valve body from fully entering the second fluid passage and yet permit fluid flow to the writing tip when the valve body is borne against the second opening.

2. A mechanism according to claim 1, wherein the second fluid passage has a generally oval cross section.

3. A mechanism according to claim 1, wherein the second fluid passage has a generally elliptical cross section.

4. A mechanism according to claim 1, wherein the valve body is generally spherical in shape.

5. A mechanism according to claim 1, wherein a majority of a length of the valve chamber between the valve seat and the entry to the second fluid passage is generally circular in cross section.

6. A mechanism according to claim 1, wherein the second opening of the second fluid passage defines a tapered entry around a periphery of the second opening, and wherein the valve body when borne against the second opening seats in the tapered entry.

7. A mechanism according to claim 1, wherein the valve chamber, first fluid passage, and second fluid passage are each integrally provided as part of a coupling assembled between the writing tip and the fluid reservoir of the writing implement.

8. A back flow preventing mechanism for a writing implement having a writing tip and a fluid reservoir, the mechanism comprising:
a coupling having a proximal end connected to the writing tip and a distal end connected to the fluid reservoir;
a bore extending longitudinally through a portion of the coupling from the distal end;
a valve chamber formed within the coupling;
a seat insert fitted in the bore and defining a first fluid passage in fluid communication with the valve chamber, the seat insert providing a first opening into a distal end of the valve chamber and a valve seat at the first opening;
a valve body loosely housed within the valve chamber and having a body diameter, the valve body preventing fluid back flow from the valve chamber to the first fluid passage through the first opening when borne against the valve seat; and
a second fluid passage in fluid communication with both the writing tip and the valve chamber and providing a second opening disposed at the proximal end of the valve chamber, the second fluid passage having a generally oblong cross section that is sized relative to the valve body diameter so as to prevent the valve body from fully entering the second fluid passage and yet permit fluid flow to the writing tip when the valve body is borne against the second opening.

9. A mechanism according to claim 8, wherein the coupling has a writing tip holding provision on the proximal end in fluid communication with the second fluid passage.

10. A mechanism according to claim 8, wherein a majority of a length of the valve chamber between the valve seat and the second opening is generally circular in cross section.

11. A mechanism according to claim 8, wherein the second fluid passage has a generally oval cross section.

12. A mechanism according to claim 8, wherein the second fluid passage has a generally elliptical cross section.

13. A mechanism according to claim 8, wherein the valve body has generally spherical shape.

14. A writing implement comprising:
a writing tip with a writing ball;
an ink reservoir with a store of ink;
a coupling having a proximal end connected in fluid communication with the writing tip and a distal end connected in fluid communication with the ink reservoir;
a valve chamber formed within the coupling and having a generally circular cross section;
a bore extending longitudinally through a portion of the coupling from the distal end to one end of the valve chamber;
a seat insert fitted in the bore and defining a first ink passage between the ink reservoir and the valve chamber, the seat insert providing a first opening into the valve chamber and a defining valve seat at the first opening;
a generally spherical valve body loosely housed within the valve chamber and having a body diameter, the valve body preventing ink back flow from the valve chamber to the first ink passage through the first opening when borne against the valve seat; and
a second ink passage in fluid communication with both the writing tip and the valve chamber and providing a second opening to the valve chamber opposite the first opening, the second ink passage having a generally oblong cross section that is sized relative to the valve body diameter so as to prevent the valve body from fully entering the second ink passage and yet permit ink flow to the writing tip when the valve body is borne against the second opening.

15. A writing implement according to claim 14, wherein the coupling is molded from a plastic material.

16. A writing implement according to claim 14, wherein the coupling further comprises:
a generally circular cross section opening at the proximal end adjacent the second ink passage in which the writing tip is inserted.

17. A writing implement according to claim 14, wherein the ink reservoir further comprises:
a cylindrical ink refill tube telescoped over the distal and of the coupling.

18. A writing implement according to claim 14, wherein the second ink passage has a generally oval cross section.

19. A writing implement according to claim 14, wherein the second ink passage has a generally elliptical cross section.

20. A writing implement according to claim 14, wherein the second ink passage has a generally rectangular cross section.
